(19) United States
(12) Patent Application Publication
(10) Pub. No.: US 2010/0180183 A1
(43) Pub. Date: Jul. 15, 2010

(54) CIRCUIT FOR REDUCING THE READ DISTURBANCE IN MEMORY

(75) Inventors: Shuo-Nan Hung, Hsinchu County (TW); Chun-Hsiung Hung, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MACRONIX INTERNATIONAL CO., LTD., Hsinchu (TW)

(21) Appl. No.: 12/351,984

(22) Filed: Jan. 12, 2009

(51) Int. Cl. G06F 11/10

(52) U.S. Cl. 714/807; 714/E11.053

(57) ABSTRACT

A memory includes an internal data block and a temporary storing unit. The internal data block stores internal data of the memory. The temporary storing unit temporarily stores the internal data of the memory after the memory is powered on.

### BACKGROUND OF THE INVENTION

1. Field of the Invention

The invention relates in general to a memory, and more particularly to a memory with reduced read disturb, for example, the NAND Flash.

2. Description of the Related Art

The one time programmable (OTP) technology in the field of the memory has been frequently used in the data protection field. The memory usually has an internal data block for storing internal data, including the special chip parameter information or security information, by the OTP technology. The internal data only can be read by the memory itself, and cannot be accessed by the external user command. The memory is verified according to the security information and can thus access the main memory block thereof. However, when the memory is read many times, the problem of read disturb occurs so that the correct security information cannot be read and the verification fails.

### SUMMARY OF THE INVENTION

The invention is directed to a memory having the reduced influence of read disturb and the enhanced reliability by reading the correct security information.

According to a first aspect of the present invention, a memory including an internal data block and a temporary storing unit is provided. The internal data block stores internal data of the memory. The temporary storing unit temporarily stores the internal data of the memory after the memory is powered on.

According to a second aspect of the present invention, a memory including an internal data block and an error correction circuit is provided. The internal data block stores internal data of the memory and an error correction code. The error correction circuit makes the memory correctly read the internal data according to the error correction code.

According to a third aspect of the present invention, a memory including a main memory block and an internal data block is provided. The internal data block stores internal data of the memory. At least two rows of memory cells of the internal data block store the same internal data. The memory is verified according to the internal data after the memory is powered on so that an external host can access the main memory block.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a memory according to a first embodiment of the invention.

FIG. 2 is a schematic illustration showing a memory according to a second embodiment of the invention.

FIG. 3A is a partial circuit diagram showing an internal data block according to a third embodiment of the invention.

FIG. 3B is a distribution graph showing a threshold voltage distribution of the memory cells according to the third embodiment of the invention.

### DETAILED DESCRIPTION OF THE INVENTION

The invention provides a memory using a temporary storing unit or an error correction circuit to read the correct security information so that the influence of read disturb can be reduced and the reliability of the memory can be enhanced.

### First Embodiment

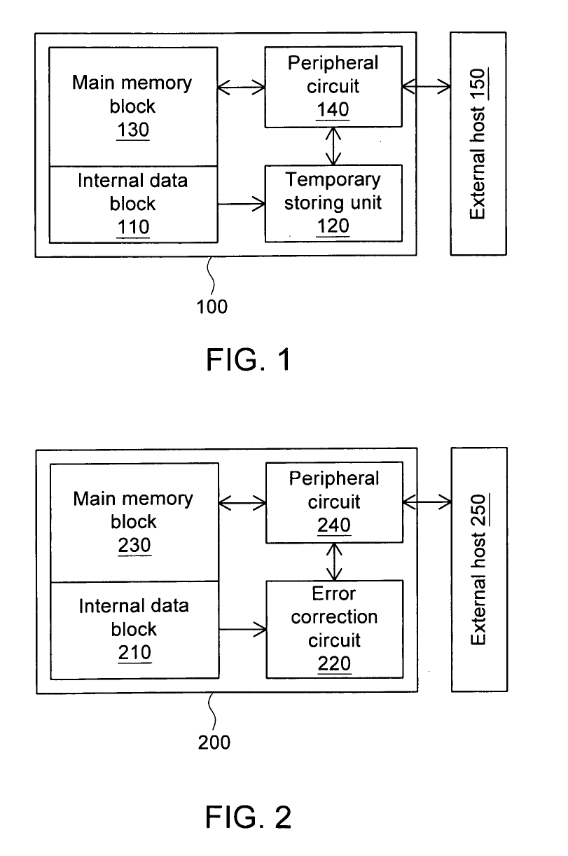

FIG. 1 is a schematic illustration showing a memory 100 according to the first embodiment of the invention. Referring to FIG. 1, the memory 100 includes an internal data block 110, a temporary storing unit 120, a main memory block 130 and a peripheral circuit 140. The internal data block 110 stores internal data of the memory 100. The internal data includes the special chip parameter or security information of the memory. The security information may be, for example, a pre-stored code for chip access authorization.

After the memory 100 is powered on, the memory downloads and temporarily stores the internal data of the internal data block 110 to the temporary storing unit 120. The temporary storing unit 120 is, for example, a static random access memory (SRAM) or a register. The memory 100 is verified according to the internal data temporarily stored in the temporary storing unit 120 so that an external host 150 can access the main memory block 130 through the peripheral circuit 140.

Thereafter, the memory 100 reads the internal data mainly through the temporary storing unit 120. Because the memory 100 only read the internal data block 110 once after the memory is powered on, the number of reading the internal data block 110 is greatly reduced. So, the influence of the read disturb can be minimized, and the read reliability is greatly enhanced.

### Second Embodiment

FIG. 2 is a schematic illustration showing a memory 200 according to the second embodiment of the invention. Referring to FIG. 2, the memory 200 includes an internal data block 210, an error correction circuit 220, a main memory block 230 and a peripheral circuit 240. The internal data block 210 is an isolated block for storing internal data and an error correction code (ECC) of the memory 200. The internal data includes the special chip parameter information or security information of the memory. The security information may be, for example, a pre-stored code for chip access authorization. The internal data block 210 preferably includes, without limitation to, only one row of memory cells.

After the memory 200 is powered on, the error correction circuit 220 corrects the internal data according to the error correction code stored in the internal data block 210. So, an external host 250 may access the main memory block 230 according to the verification with the internal data through the peripheral circuit 240. In the internal data block 210, the error correction code may adopt the error correction code system, such as the repetition scheme or the Hamming code, and the error correction circuit 220 can be implemented without the need of the complicated circuit.

Because the error correction code exists, the memory 200 can correctly read the internal data stored in the internal data block 210 and is free from the influence of the read disturb. Thus, the read reliability is enhanced while the problem of the memory data retention time is also solved.

### Third Embodiment

A memory according to the third embodiment of the invention includes a main memory block and an internal data block. The main memory block stores data with the format of a multi-level unit (MLC). However, the invention is not limited thereto. The internal data block may store the internal data of the memory with the format of a single level unit (SLC) but it is not limited thereto, and at least two rows of memory cells of the internal data block store the same internal data. The internal data includes the special chip parameter information or security information of the memory. The memory is verified according to the internal data after the memory is powered on so that an external host can access the main memory block.

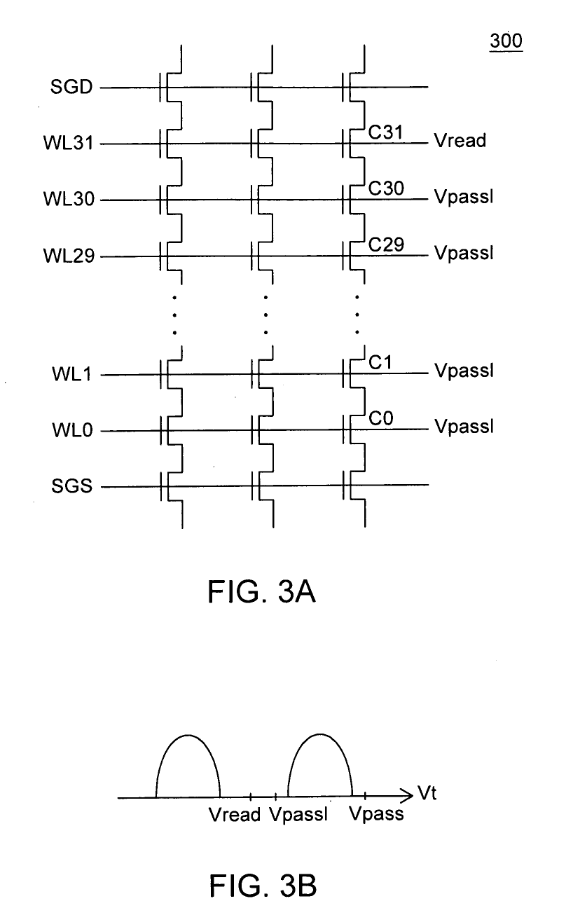

FIG. 3A is a partial circuit diagram showing an internal data block 300 according to the third embodiment of the invention. Referring to the illustrated example of FIG. 3A, the internal data block 300 includes 32 rows of memory cells. However, the invention is not limited thereto. At least two rows of memory cells of the internal data block 300, such as two rows of memory cells corresponding to word lines WL30 and WL31, store the same internal data, and the other rows of memory cells are in an erased state. Preferably, the 32 rows of memory cells of the internal data block 300 store the same internal data, such that memory cells of the same bit line of the internal data block 300 store the same data. For example, memory cells C0-C31 all store “0” or “1”.

FIG. 3B is a distribution graph showing a threshold voltage distribution of the memory cells according to the third embodiment of the invention. When the conventional memory wants to read the internal data of the internal data block 300 (e.g., the target cell C31), a read voltage Vread is usually applied to a word line WL31, and a pass voltage Vpass is applied to word lines WL0 to WL30 corresponding to the memory cells, which have not been read. In the third embodiment of the invention, the internal data is stored into the single memory block with the format of the single level unit. So, a low pass voltage Vpass1 may be applied to the word lines WL0 to WL30 corresponding to the other memory cells that are in erased state or have the same threshold voltage with the target cell C31. The low pass voltage is between a read voltage and a low bound of high threshold voltage distribution. Consequently, the memory cell with the higher threshold voltage generates the lower current. That is, the contrast between data “0” and data “1” is increased so that the read window of the memory is relatively increased, the influence of the read disturb is reduced due to the low pass voltage, and the read reliability is enhanced.

The technical characteristics of the first to third embodiments of the invention may be implemented alone or integrally without any restrictive purpose. The integrally implemented technical characteristics are also the same as those of the first to third embodiments, so detailed descriptions thereof will be omitted.

In the memory according to each embodiment of the invention, the internal data is firstly downloaded and temporarily stored to the temporary storing unit after the memory is powered on, the error correction circuit is adopted to correctly read the internal data, or the current generated by the memory cell having the high threshold voltage is reduced so that the memory is free from the influence of the read disturb and can correctly read the security information. Thus, the read reliability of the memory is enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory, comprising:
an internal data block for storing internal data of the memory; and
a temporary storing unit for temporarily storing the internal data of the memory after the memory is powered on.

2. The memory according to claim 1, wherein the internal data comprises chip parameter information of the memory.

3. The memory according to claim 2, wherein the internal data comprises security information of the memory.

4. The memory according to claim 1, wherein the memory further comprises a main memory block, and the memory is verified according to the internal data temporarily stored in the temporary storing unit after the memory is powered on so that an external host can access the main memory block.

5. The memory according to claim 1, wherein the temporary storing unit is a static random access memory or a register.

6. The memory according to claim 1, wherein the internal data block further stores an error correction code, and the memory further comprises an error correction circuit for making the memory correctly read the internal data according to the error correction code.

7. The memory according to claim 1, wherein the internal data is stored in the internal data block with a format of a single level unit (SLC), and at least two rows of memory cells of the internal data block store the same internal data.

8. A memory, comprising:
an internal data block for storing internal data of the memory and an error correction code; and
an error correction circuit for making the memory correctly read the internal data according to the error correction code.

9. The memory according to claim 8, wherein the internal data comprises chip parameter information of the memory.

10. The memory according to claim 9, wherein the internal data comprises security information of the memory.

11. The memory according to claim 8, further comprising a main memory block, wherein the internal data are corrected according to the error correction code after the memory is powered on so that an external host can access the main memory block according to the verification with the internal data.

12. The memory according to claim 8, wherein the internal data and the error correction code are stored in the internal data block with a format of a single level unit, and at least two rows of memory cells of the internal data block store the same internal data and the error correction code.

13. A memory, comprising:
a main memory block; and
an internal data block for storing internal data of the memory, wherein at least two rows of memory cells of the internal data block store the same internal data,
wherein the memory is verified according to the internal data after the memory is powered on so that an external host can access the main memory block.

14. The memory according to claim 13, wherein the internal data comprises chip parameter information or security information of the memory.

15. The memory according to claim 14, wherein the internal data comprises security information of the memory.

16. The memory according to claim 13, wherein the main memory block stores data with a format of a multi-level unit.

17. The memory according to claim 13, wherein when the memory reads the internal data, a low pass voltage is applied to a word line corresponding to a memory cell of the internal data block, which is not read.

18. The memory according to claim 17, wherein the low pass voltage is between a read voltage and a low bound of high threshold voltage distribution.

19. The memory according to claim 13, wherein the memory cells of the same bit line of the internal data block storing the same data.
